(19) United States
(12) Patent Application Publication
(10) Pub. No.: US 2011/0186761 A1
(43) Pub. Date: Aug. 4, 2011

(54) Gate valve

(75) Inventors: Chien-Ping HUANG, Tainan (TW); Tsung-Hsun HAN, Kaohsiung (TW)

(73) Assignee: HERMES-EPITEK CORPORATION, TAIPEI (TW)

(21) Appl. No.: 12/726,127

(22) Filed: Mar. 17, 2010

(30) Foreign Application Priority Data
Feb. 1, 2010 (TW) 099102840

(51) Int. Cl. F16K 1/16

(52) U.S. Cl. 251/301

(57) ABSTRACT

A gate valve includes a valve member and a valve plate. The valve member includes an opening. The valve plate is capable of sealing the opening, and is further capable of moving a proper distance and rotating a proper angle relative to the opening so as to open or seal the opening.

### CROSS-REFERENCE TO RELATED APPLICATIONS

The entire contents of Taiwan Patent Application No. 099102840, filed on Feb. 1, 2010, from which this application claims priority, are incorporated herein by reference.

### BACKGROUND OF THE INVENTION

1. Field of the Invention

The present invention generally relates to a gate valve, and more particularly to a gate valve which is applied in the contexts of vacuum equipment.

2. Description of Related Art

The setup and maintenance costs for a clean room, in which semiconductor manufacturing equipment can be installed, tend to be very high. In order to use a high-cost clean room more efficiently, the size and the operation space of its semiconductor manufacturing equipment should be minimized. The reaction chamber of a set of semiconductor manufacturing equipment usually includes a gate valve for opening or sealing the reaction chamber. Reducing the size and the operation space of this gate valve, in particular, has been a key point of interest in the designing of semiconductor manufacturing equipment for a long time.

Moreover, during a semiconductor manufacturing process, the pressure within the reaction chamber is usually lower than that of the atmosphere. Before opening the gate valve, a proper amount of gas should be purged into the reaction chamber so as to balance the pressure difference between the interior of the reaction chamber and the atmosphere. Sometimes, because of this pressure difference, the gate valve cannot be opened smoothly, and the semiconductor manufacturing equipment may need to be shut down for the gate valve operation.

For the reason that there are disadvantages of the prior art such as those mentioned above, a need exists to propose a gate valve which is suitable for application in connection with vacuum equipment. The gate valve should have a smaller size, and the gate valve should be capable of being opened smoothly on a consistent basis even when there is a pressure difference between the inside of the reaction chamber and the atmosphere.

### SUMMARY OF THE INVENTION

Accordingly, the present invention has been made in order to meet such a need as described above, and it is an object of the present invention to provide a gate valve which is integrable with vacuum equipment. The gate valve has a smaller size, and the gate valve is capable of preventing the situation where it cannot be opened smoothly because of a pressure difference between the inside of the reaction chamber and the atmosphere.

In order to achieve the above object, the present invention provides an improved gate valve. The gate valve includes a valve member and a valve plate. The valve member includes an opening. The valve plate is capable of sealing the opening, wherein the valve plate is capable of moving a proper distance and rotating a proper angle relative to the opening so as to open or seal the opening.

In accordance with the gate valve of the present invention features of having a smaller size and a capacity to be opened smoothly on a consistent basis even in the presence of a pressure difference, a number of non-obvious and non-trivial advantages can be obtained. Because the gate valve has a smaller size, a high-cost clean room can be used more efficiently. Moreover, owing to the valve plate of the gate valve being capable of moving a proper distance relative to the opening, the gate valve of the present invention is able to be opened smoothly even when a pressure difference exists between the inside of the reaction chamber and the atmosphere.

### BRIEF DESCRIPTION OF THE DRAWINGS

FIG. 1A shows a perspective view of a gate valve having a valve member and a valve plate in accordance with a preferred embodiment of the present invention;

FIG. 1B and FIG. 1C show the valve member and the valve plate of FIG. 1A, respectively; and

FIGS. 2A-2F show an operation method of the gate valve shown in FIG. 1A.

### DETAILED DESCRIPTION OF THE INVENTION

A detailed description of the present invention will be provided in the context of the following embodiments, which are not intended to limit the scope of the present invention and which can be adapted for other applications. While the drawings are illustrated with details, it is appreciated that the quantity of the disclosed components may be greater or less than that disclosed, except for instances expressly restricting the amount of the components.

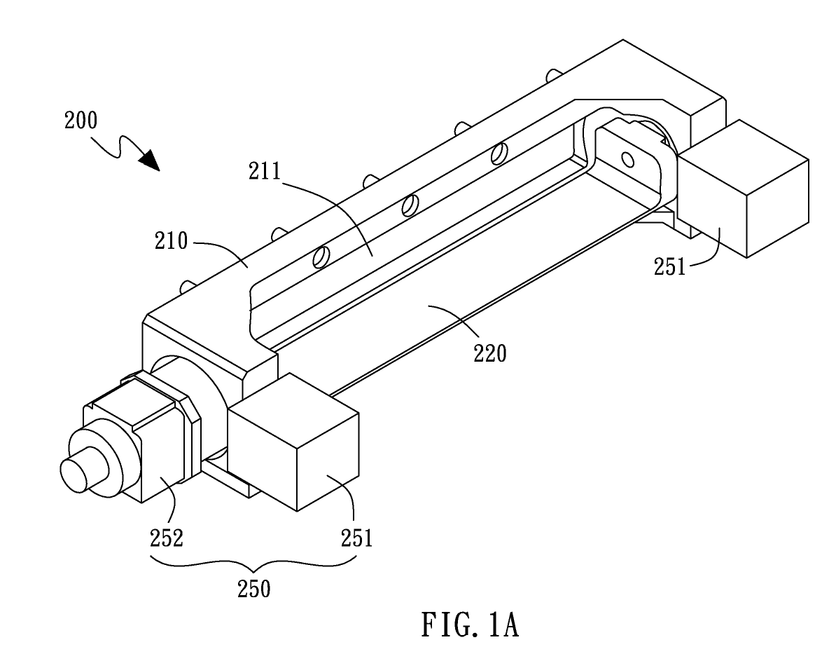

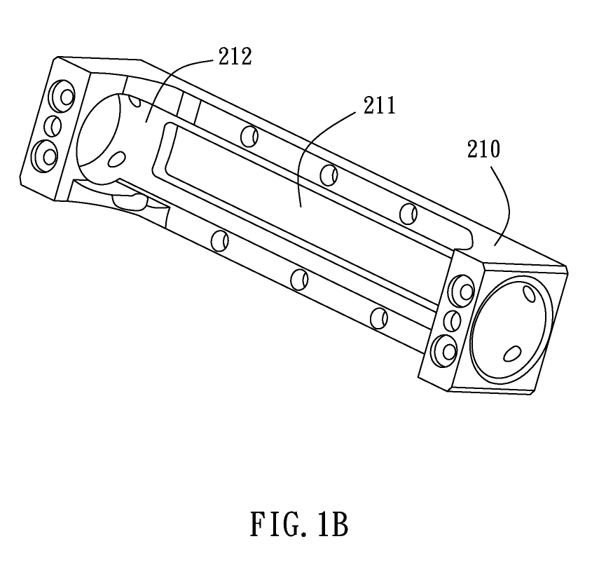

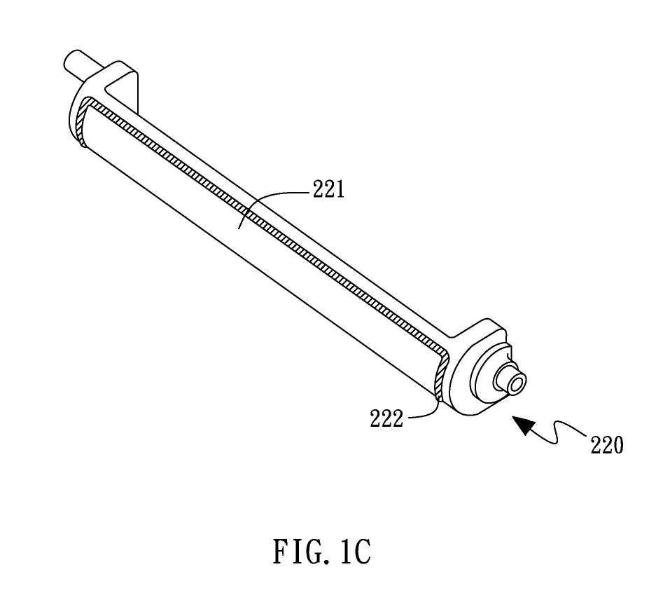

FIG. 1A shows a perspective view of a gate valve 200 in accordance with a preferred embodiment of the present invention. The gate valve 200 includes a valve member 210 and a valve plate 220. The valve member 210 includes an opening 211. The valve plate 220 is capable of sealing the opening 211. Moreover, the gate valve 200 includes a driving device 250. The driving device 250 includes a linear moving device 251 and a rotating device 252 so as to make the valve plate 220 move or rotate relative to the opening 211. During opening of the gate valve 200, the valve plate 220 moves a proper distance relative to the opening 211, and then the valve plate 220 rotates a proper angle so as to open the opening 211.

In this embodiment, the linear moving device 251 is an air cylinder, and the rotating device 252 is an electric motor, but the invention is not limited to this. Any device which has the same function can be considered for such use. For example, the linear moving device 251 can be a liquid cylinder, a linear motor, a lead screw device with a driving motor, or any other driving device which can perform linear movement. The rotating device 252 can be a rotating cylinder, a step motor, a gear assembly with a driving motor, or any other driving device which can perform a rotating movement.

FIG. 1B and FIG. 1C show isolated views of the valve member 210 and the valve plate 220 of FIG. 1A, respectively. The valve member 210 includes a first curved surface 212 and the valve plate 220 includes a second curved surface 221, wherein the second curved surface 221 conforms to the first curved surface 212. Moreover, the gate valve 200 can further include a seal ring 222, wherein the seal ring 222 is disposed on the second curved surface 221 of the valve plate 220. During opening of the gate valve 200, the valve plate 220 moves a proper distance relative to the opening 211 for making the seal ring 222 leave the first curved surface 212 linearly. According to one implementation of the invention, in connection with movement of the valve plate the proper distance the seal ring leaves said first curved surface linearly so as to prevent, reduce, and/or optimize an amount of friction between the seal ring 222 and the first curved surface 212. Thus, operation of the seal ring 222 is enhanced, such that, for example, its lifetime is extended to the degree or extent that wear is reduced and/or it is prevented from being worn out.

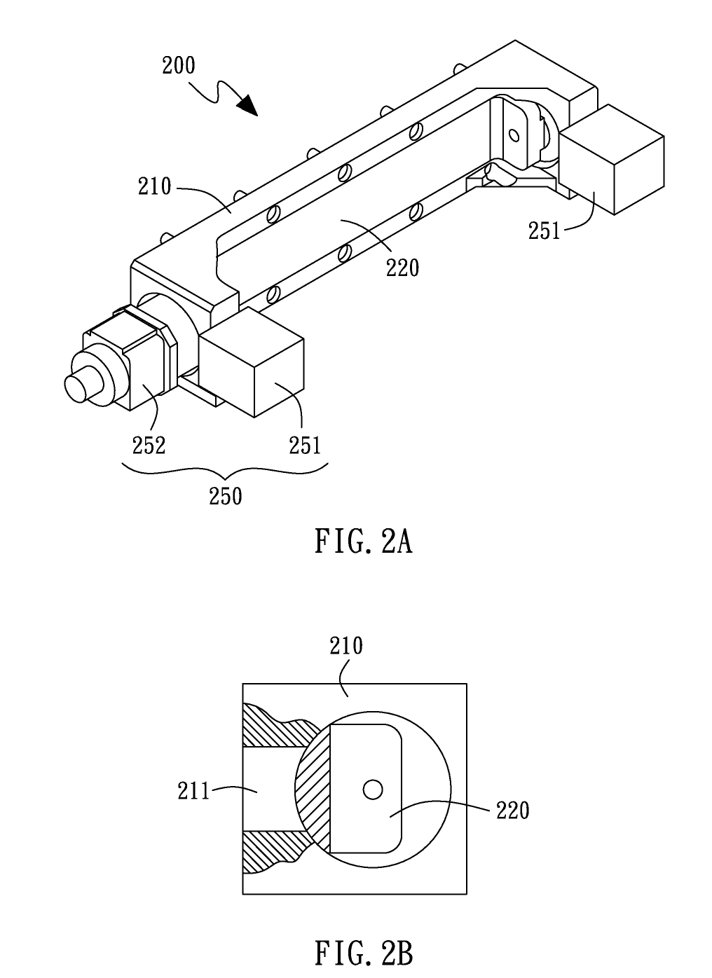

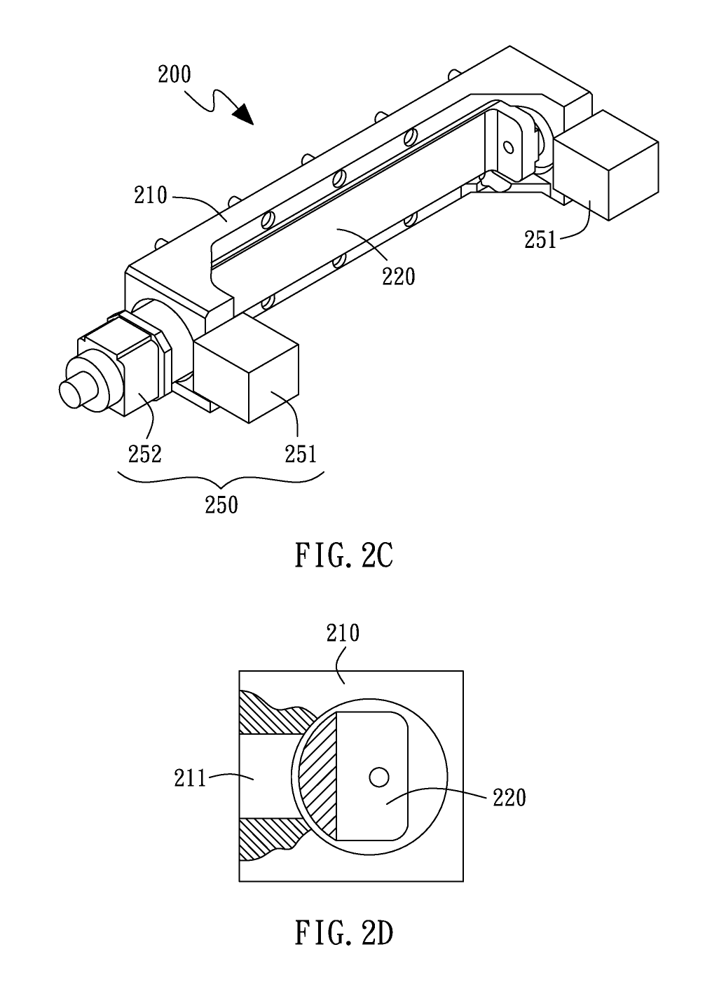

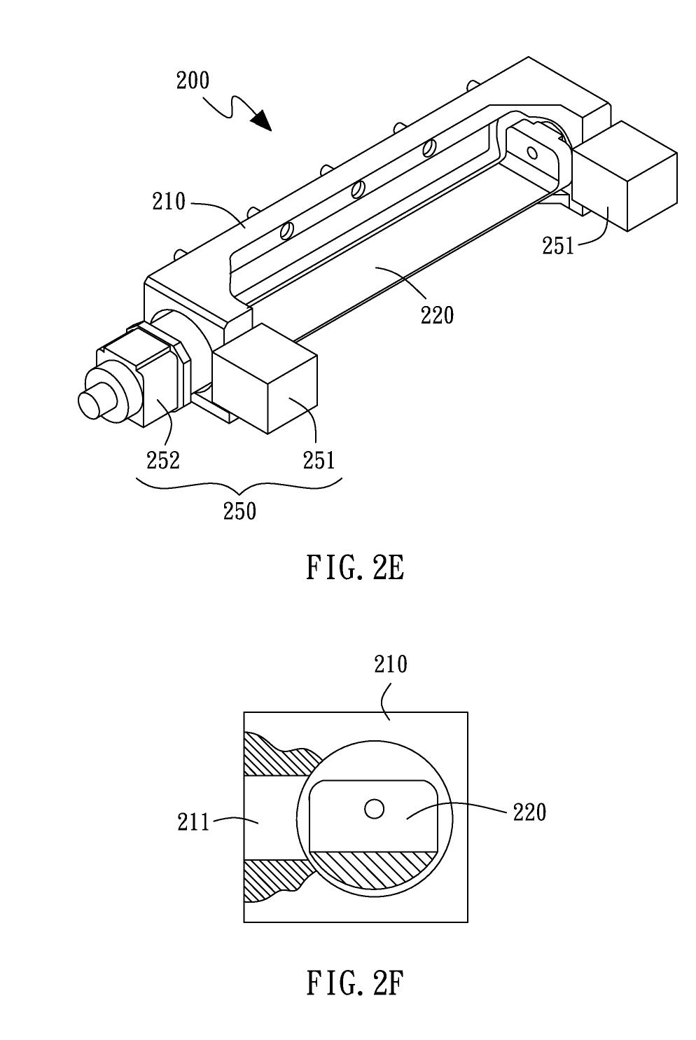

FIGS. 2A-2F show an operation method of the gate valve shown in FIG. 1. Referring to FIGS. 2A and 2B, the opening 211 is sealed by the valve plate 220, wherein the second curved surface 221 conforms to the first curved surface 212. Then, referring to FIGS. 2C and 2D, the valve plate 220 moves a proper distance relative to the opening 211 for making the seal ring 222 leave the first curved surface 212 linearly so as to prevent the seal ring 222 from being worn out. In this embodiment, the proper distance is about 5 mm, but the invention is not limited to this. Different proper distances which have the same function can be used for different designs. Then, referring to FIGS. 2E and 2F, the valve plate 220 rotates a proper angle relative to the opening 211 so as to expose the opening 211. In this embodiment, the proper angle is about 90 degrees, noting again that the invention need not be so limited. Different proper angles which have the same function can be used for different designs.

The gate valve of the present invention has a smaller size relative to corresponding structures of the prior art, and the gate valve is capable of preventing the situation where it cannot be opened smoothly because of the pressure difference. The gate valve's smaller size can enable a high-cost clean room to be used more efficiently. Moreover, the valve plate of the gate valve is capable of moving a proper distance relative to the opening and being opened smoothly even in the presence of pressure differences which would prevent such operation in prior-art devices.

The present invention also provides a method for opening or sealing a chamber of semiconductor equipment. The method includes the following steps. Referring to FIGS. 2A-2F, a gate valve is provided. The gate valve is disposed on the chamber of the semiconductor equipment, wherein the gate valve includes a valve member and a valve plate. The valve member has an opening, and the valve plate is capable of sealing the opening. The valve plate is configured to open the opening from (i.e., by operation of) a movement along a proper distance relative to the opening prior to a rotation through a proper angle. Following provision of the gate valve on the chamber, the steps for opening the gate valve can be performed. During opening of the gate valve, the valve plate moves the proper distance relative to the opening, and then the valve plate rotates the proper angle so as to expose the opening.

The valve plate is further configured to seal the opening from (i.e., by operation of) a rotation through a proper angle relative to the opening so as to dispose the valve plate towards the opening prior to a movement along a proper distance. Steps for sealing the gate valve are opposite to the steps for opening the gate valve. During sealing of the opening, the valve plate rotates the proper angle relative to the opening so as to dispose the valve plate towards the opening, and then the valve plate moves the proper distance so as to seal the opening. In this embodiment, the proper distance is about 5 mm, but is not limited to this. Different proper distances which have the same function can be used for different designs. In this embodiment, the proper angle is about 90 degrees, but is not limited to this. Different proper angles which have the same function can be used for different designs.

Although specific embodiments have been illustrated and described, it will be appreciated by those skilled in the art that various modifications may be made without departing from the scope of the present invention, which is intended to be limited solely by the appended claims.

What is claimed is:

1. A gate valve, comprising:
a valve member, said valve member having an opening; and
a valve plate, said valve plate being capable of sealing said opening, wherein said valve plate is capable of moving a proper distance and rotating a proper angle relative to said opening so as to open or seal said opening.

2. The gate valve according to claim 1, wherein said valve plate is configured to open said opening from a movement along said proper distance, relative to said opening, prior to a rotation through said proper angle.

3. The gate valve according to claim 1, wherein said valve plate is configured to seal said opening from a rotation through said proper angle relative to said opening, so as to dispose said valve plate towards said opening, prior to a movement along said proper distance.

4. The gate valve according to claim 1, wherein said proper distance is about 5 mm.

5. The gate valve according to claim 1, wherein said proper angle is about 90 degrees.

6. The gate valve according to claim 1, further comprising a seal ring, wherein said seal ring is disposed on said valve plate such that when said valve plate moves said proper distance relative to said opening said seal ring is capable of leaving said valve member linearly so as to prevent said seal ring from being worn out.

7. The gate valve according to claim 1, wherein said valve member comprises a first curved surface, said valve plate comprises a second curved surface, and said second curved surface conforms to said first curved surface.

8. The gate valve according to claim 7, further comprising a seal ring, wherein said seal ring is disposed on said second curved surface such that, with movement of said valve plate said proper distance relative to said opening, said seal ring is capable of leaving said first curved surface linearly so as to prevent said seal ring from being worn out.

9. The gate valve according to claim 1, further comprising a linear moving device, wherein said linear moving device is capable of making said valve plate move said proper distance relative to said opening.

10. The gate valve according to claim 9, wherein said linear moving device is an air cylinder.

11. The gate valve according to claim 1, further comprising a rotating device, wherein said rotating device is capable of making said valve plate rotate said proper angle relative to said opening.

12. The gate valve according to claim 11, wherein said rotating device is an electric motor.

13. A method for opening or sealing a chamber of semiconductor equipment, comprising:
providing a gate valve, said gate valve being disposed on said chamber of said semiconductor equipment, wherein said gate valve comprises a valve member and a valve plate, said valve member has an opening, and said valve plate is capable of sealing said opening; and
making said valve plate move a proper distance and rotate a proper angle relative to said opening so as to open or seal said opening.

14. The method for opening or sealing a chamber of semiconductor equipment according to claim 13, wherein while opening said opening, said valve plate moves said proper distance relative to said opening, and then said valve plate rotates said proper angle so as to expose said opening.

15. The method for opening or sealing a chamber of semiconductor equipment according to claim 13, wherein while sealing said opening, said valve plate rotates said proper angle relative to said opening so as to dispose said valve plate towards said opening, and then said valve plate moves said proper distance.

16. The method for opening or sealing a chamber of semiconductor equipment according to claim 13, wherein said proper distance is about 5 mm.

17. The method for opening or sealing a chamber of semiconductor equipment according to claim 13, wherein said proper angle is about 90 degrees.

18. The method for opening or sealing a chamber of semiconductor equipment according to claim 13, whereby movement of said valve plate said proper distance relative to said opening makes a seal ring leave said first curved surface linearly so as to reduce wear on said seal ring.
